(19) United States
(12) Patent Application Publication
(10) Pub. No.: US 2026/0348185 A1
(43) Pub. Date: Nov. 5, 2026

(54) WIND PROOF STRUCTURE

(71) Applicant: Pedro Bento Collier, JR., The Villages, FL (US)

(72) Inventor: Pedro Bento Collier, JR., The Villages, FL (US)

(21) Appl. No.: 19/296,049

(22) Filed: Aug. 11, 2025

Related U.S. Application Data
(60) Provisional application No. 63/683,383, filed on Aug. 15, 2024.

(51) Int. Cl. E04H 9/14

(52) U.S. Cl. CPC E04H 9/14

(57) ABSTRACT

A wind proof structure includes a foundation block, a running beam anchored to the foundation block, a plurality of perimeter columns anchored to the running beam, a centrally located capital column anchored to the running beam, a plurality of beams attached to the plurality of perimeter columns and the capital column; and a dome-shaped roof anchored to the plurality of perimeter columns and the capital column. An exterior surface of at least one of the plurality of perimeter columns defines an angle, A, with respect to the running beam between about 100 degrees and about 120 degrees, thereby causing wind to deflect and dissipate causing less pressure on the wind proof structure. The foundation block, the running beam, the exterior walls, the perimeter columns, the capital column and the dome-shaped roof are anchored to each other in such a way to form a monolithic structure.

### CLAIM TO PRIORITY

This application claims the benefit of U.S. Provisional Application No. 63/683,383, filed on Aug. 15, 2024, the entire contents of which are incorporated herein by reference.

### FIELD OF THE INVENTION

The invention is generally directed to structures that protect against wind damage. In particular, this invention is directed to wind proof structures that protect against wind damage, such as from tornados and hurricanes.

### BACKGROUND OF THE INVENTION

It is well known that hurricanes and tornados create storm wind forces capable of damaging and/or destroying standard residential and commercial constructions. Windstorm forces are known to remove and/or compromise the primary sealing systems of shingles, roofing, siding, and veneers. Furthermore, windstorm forces are well known to lift off entire roof systems and blow down and/or suck out walls.

The winds associated with tornado and hurricane storms are known to include destructive straight-line winds and other destructive forces that impose torsion forces upon a structure to effectively twist it apart. In addition, tornado and hurricane storms buffet structures with seismic type forces that effectively weaken the holding power of traditional fasteners like nails and screws. Furthermore, tornado storms include a vortex, and sometimes several smaller vortices inside of a large vortex, which impose a spiraling shell of wind capable of imposing an effective dynamic wall of wind known to apply impact forces to a structure, capable of effectively bumping and/or knocking it down, not just blowing it down.

In view of the foregoing, there is a need to provide a wind proof structure that is capable of withstanding tornado and hurricane force winds.

### SUMMARY OF THE INVENTION

The problem associated with building integrity during a tornado and hurricane is solved by providing a wind proof structure that forms a monolithic structure with angled exterior walls and roof to allow the wind force to pass smoothly over the wind proof structure.

In one aspect, a wind proof structure comprises a foundation block, a running beam anchored to the foundation block, a plurality of perimeter columns anchored to the running beam, a centrally located capital column anchored to the running beam, a plurality of beams attached to the plurality of perimeter columns and the capital column; and a dome-shaped roof anchored to the plurality of perimeter columns and the capital column. An exterior surface of at least one of the plurality of perimeter columns defines an angle, A, with respect to the running beam between about 100 degrees and about 120 degrees, thereby causing wind to deflect and dissipate causing less pressure on the wind proof structure. The foundation block, the running beam, the exterior walls, the perimeter columns, the capital column and the dome-shaped roof are anchored to each other in such a way to form a monolithic structure.

In another aspect, a wind proof structure comprises a foundation block. A running beam is anchored to the foundation block. A plurality of perimeter columns are anchored to the running beam. A centrally located capital column is anchored to the running beam, and a dome-shaped roof anchored to the plurality of perimeter columns and the capital column. An exterior surface of the wind proof structure defines an angle, A, with respect to the running beam, thereby causing wind to deflect and dissipate causing less pressure on the wind proof structure, and the foundation block, the running beam, the exterior walls, the perimeter columns, the capital column and the dome-shaped roof are anchored to each other in such a way to form a monolithic structure that acts as if the wind proof structure is made of a single piece of material.

### BRIEF DESCRIPTION OF THE DRAWINGS

While various embodiments of the invention are illustrated, the embodiments shown should not be construed to limit the claims. It is anticipated that various changes and modifications may be made without departing from the scope of this invention.

FIG. 1 is a top view of the wind proof structure according to an aspect of the invention showing the round shape of the structure with a dome-shaped roof;

FIG. 2 is a front view of the wind proof structure of FIG. 1 showing the profile of the structure with inclined exterior walls and dome-shaped roof;

FIG. 3 is a top view of the round-shaped wind proof structure with the dome-shaped roof of FIG. 1 showing the structural elements of the wind proof structure, such as capital column, edge columns and running beams;

FIG. 4 is a cross-sectional view taken along line 4-4 of FIG. 3 showing the basic components of the wind proof structure including the angled concrete walls and round, dome-shaped roof;

FIG. 5 is a top view of the wind proof structure according to an aspect of the invention showing a hexagonal-shaped wind proof structure;

FIG. 6 is a front view of the wind proof structure of FIG. 5 showing the profile of the hexagonal-shaped wind proof structure with inclined exterior walls and hexagonal-shaped roof;

FIG. 7 is a top view of the hexagonal-shaped roof of FIG. 5 showing the structural elements of the hexagonal-shaped wind proof structure, such as capital column, edge columns and running beams;

FIG. 8 is a cross-sectional view taken along line 8-8 of FIG. 7 showing the basic components of the hexagonal-shaped wind proof structure including the angled concrete walls and hexagonal, dome-shaped roof;

FIG. 9 is a top view of the wind proof structure according to an aspect of the invention showing an octagon-shaped wind proof structure;

FIG. 10 is a front view of the octagon-shaped wind proof structure of FIG. 9 showing the profile of the octagon-shaped wind proof structure with inclined exterior walls and octagon-shaped roof;

FIG. 11 is a top view of the round, dome-shaped steel roof of FIG. 9 showing the structural elements of the octagon-shaped wind proof structure, such as capital column, edge columns and running beams; and

FIG. 12 is a cross-sectional view taken along line 12-12 of FIG. 11 showing the basic components of the octagon-shaped wind proof structure including the angled concrete walls and octagon, dome-shaped roof.

### DETAILED DESCRIPTION OF THE DISCLOSURE

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Throughout the text and the claims, use of the word “about” in relation to a range of values (e.g., “about 22 to 35 wt. %”) is intended to modify both the high and low values recited, and reflects the penumbra of variation associated with measurement, significant figures, and interchangeability, all as understood by a person having ordinary skill in the art to which this invention pertains.

For purposes of this specification (other than in the operating examples), unless otherwise indicated, all numbers expressing quantities and ranges of ingredients, process conditions, etc. are to be understood as modified in all instances by the term “about”. Accordingly, unless indicated to the contrary, the numerical parameters set forth in this specification and attached claims are approximations that can vary depending upon the desired results sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Further, as used in this specification and the appended claims, the singular forms “a”, “an” and “the” are intended to include plural referents, unless expressly and unequivocally limited to one referent.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements including that found in the measuring instrument. Also, it should be understood that any numerical range recited herein is intended to include all sub-ranges subsumed therein. For example, a range of “1 to 10” is intended to include all sub-ranges between and including the recited minimum value of 1 and the recited maximum value of 10, i.e., a range having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

In the following specification and the claims, a number of terms are referenced that have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

As used herein, an “anchor” is defined as something that serves to hold an object firmly in place.

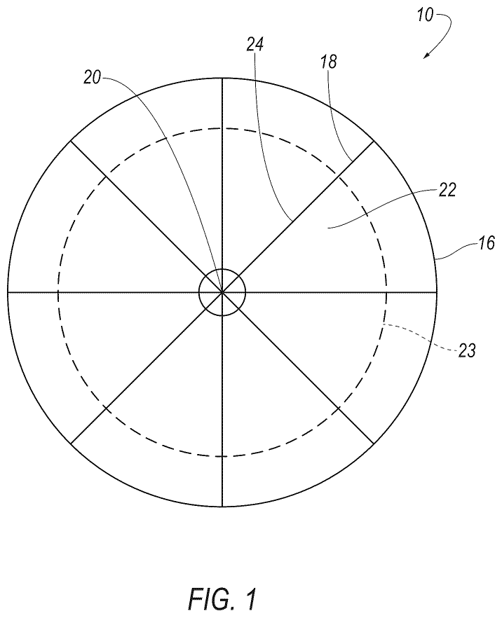

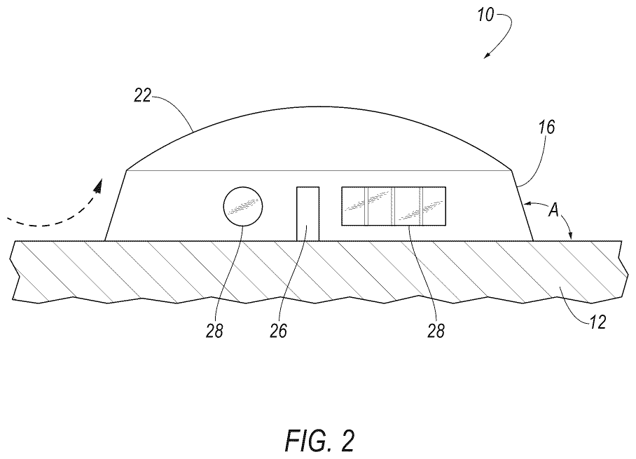

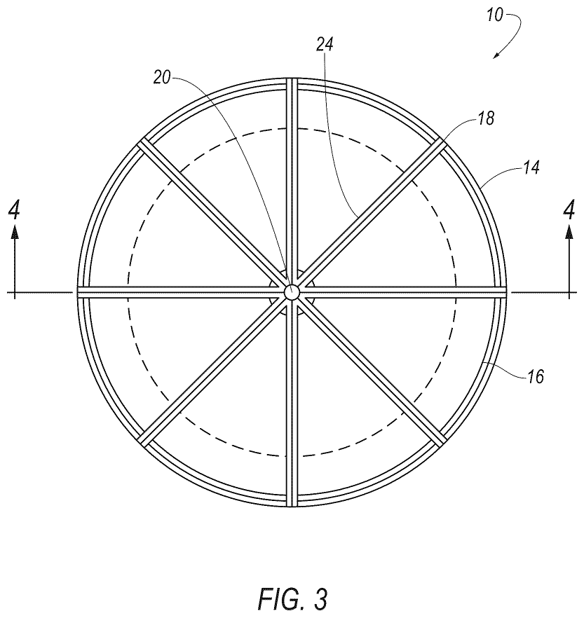

Referring to the drawings, FIGS. 1-4 show a wind proof structure, generally designated as 10, according to an embodiment of the invention. In general, the wind proof structure 10 can have a generally circular or round exterior shape. The wind proof structure 10 has a foundation block 12 made of a suitable material, such as steel, concrete, reinforced cement concrete (RCC), and the like, and a running beam 14 made of suitable material, such as steel, concrete, reinforced cement concrete (RCC), and the like, anchored to the foundation block 12. The foundation block 12 should be suitably heavy to properly anchor the remainder of the wind proof structure 10 against forces due to strong winds. Exterior or perimeter walls 16, a plurality of perimeter columns 18 located equidistantly about the perimeter of the wind proof structure 10 and a capital column 20 located approximately in the center of the wind proof structure 10 are all anchored to the running beam 14. In the illustrated example, the wind proof structure 10 has a total of eight (8) perimeter columns 18 spaced equidistantly about the perimeter of the wind proof structure 10.

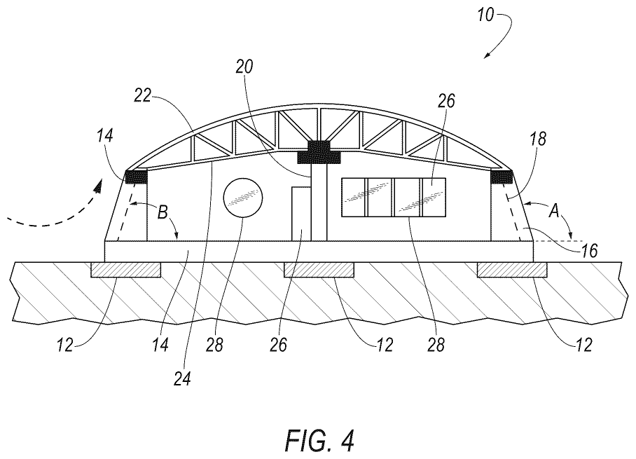

A dome-shaped or circular-shaped roof 22 is anchored to a plurality of beams 24 mounted on the perimeter columns 18 and the capital column 20. The dome-shaped roof 22 is flush with the exterior or perimeter walls 16 to allow the wind force to pass smoothly over the wind proof structure 10 (i.e., no deflection). The perimeter or exterior walls 16, the perimeter columns 18, the capital column 20 and the roof 22 are preferably made of a suitable structural material, such as steel, concrete, reinforced cement concrete (RCC), titanium, and the like. It will be appreciated that the invention is not limited by the structural material used in the construction of the wind proof structure 10, and that the invention can be practiced using any suitable structural material. The exterior or perimeter walls 16 of the wind proof structure 10 are formed at an angle, A, with respect to running beam 14, as shown in FIG. 4. The angle, A, can be between about 100 degrees and about 120 degrees, and consequently the interior angle, B, can be between about 80 degrees and about 60 degrees. It should be appreciated that the magnitude of the angle, A, (and angle, B) can vary to provide the proper amount of deflection and dissipating strong winds, thereby causing less pressure on the wind proof structure 10. The foundation block 12, the running beam 14, the exterior or perimeter walls 16, the perimeter columns 18, the capital column 20 and the dome-shaped roof 22 are anchored to each other in such a way to form a monolithic structure that acts as if the wind proof structure 10 is made of a single piece of material.

The wind proof structure 10 includes at least one door or portal 26 to allow entry into the wind proof structure 10 and one or more windows 28 to allow light to pass into the wind proof structure 10. The door 26 is made of wind resistant material, such as wood, steel, concrete, and the like. The windows 28 2 can be made of hurricane proof material, such as plastic, glass, and the like. The windows 28 may be provided with shutters (not shown) that can be deployed when needed to prevent breakage of the window 28. The area of the interior of the wind proof structure 10 can be any desirable amount, depending on the possible use, for example, a home, a community shelter, and the like.

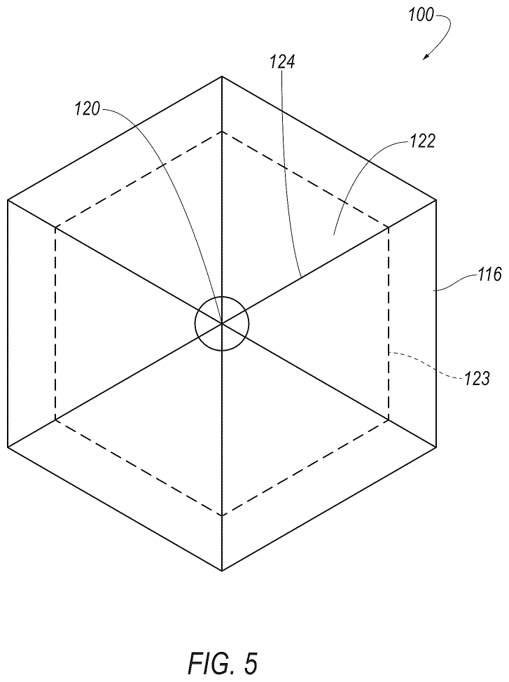

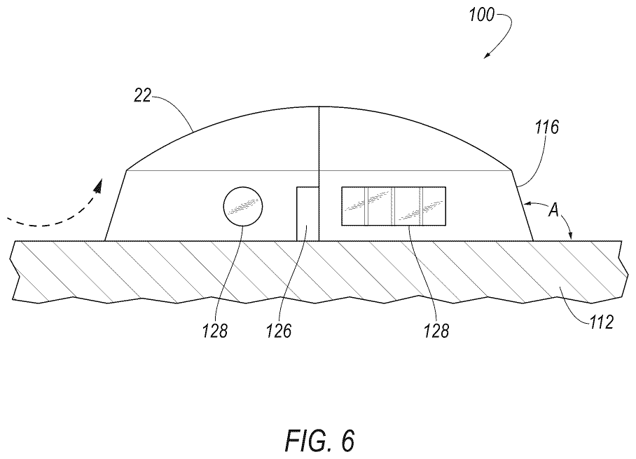

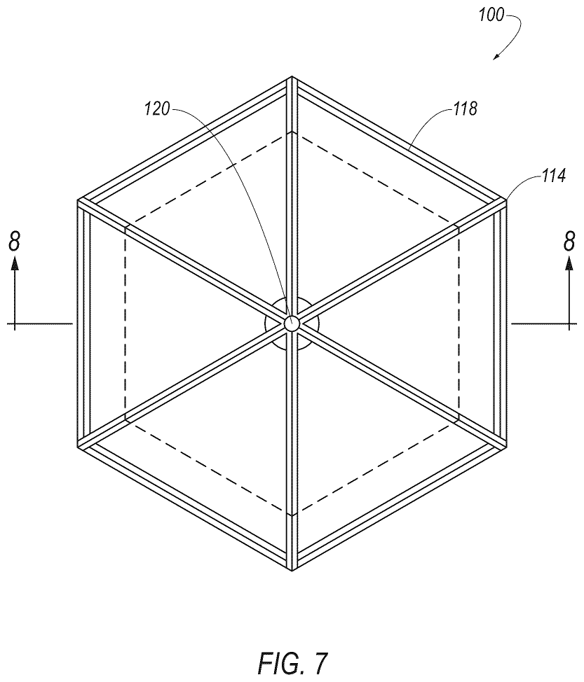

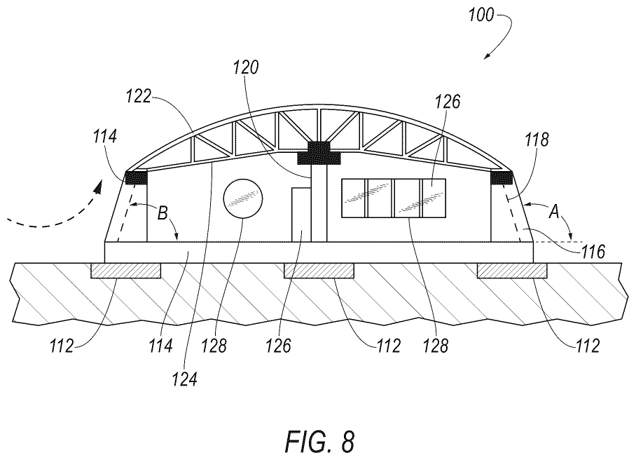

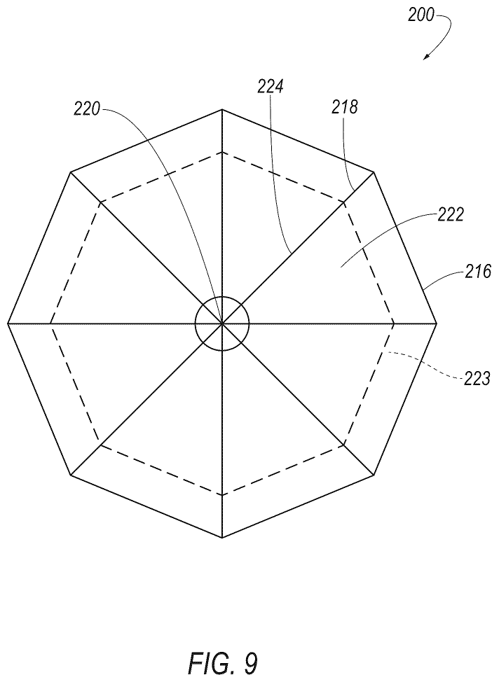

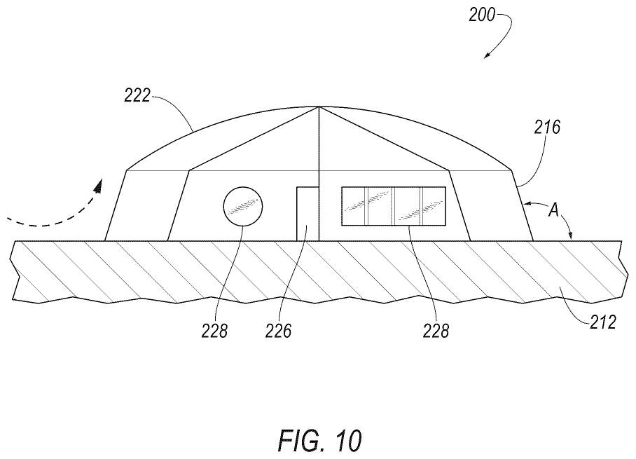

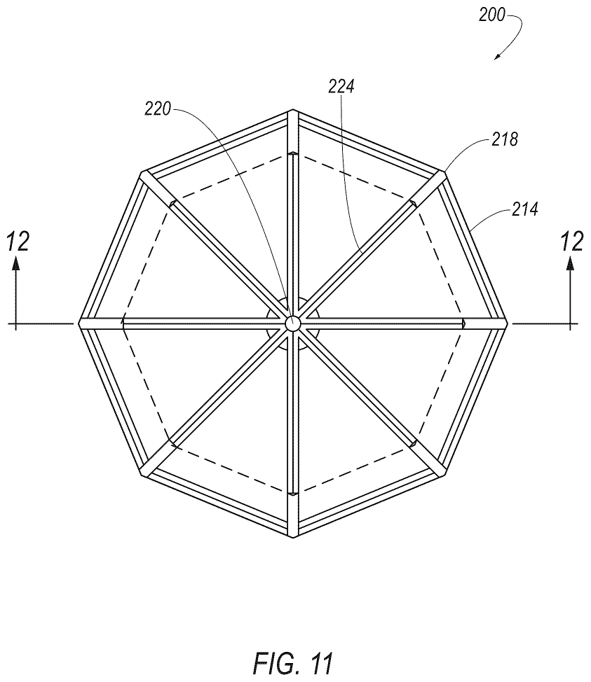

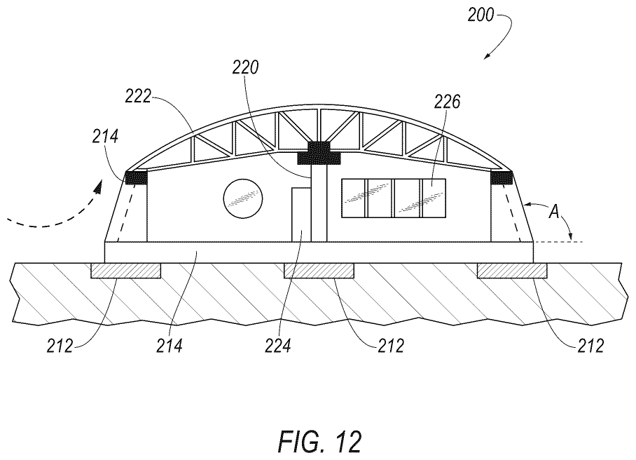

The invention is not limited by the exterior shape of the wind proof structure 10. In FIGS. 1-4, the wind proof structure 10 has a generally round or circular exterior shape. In FIGS. 5-8, the wind proof structure 100 has a generally polygonal exterior shape, and in particular, a hexagonal shape. In FIGS. 5-8, the same element of the wind proof structure 10 is given the same reference number with the addition of one hundred. In FIGS. 9-12, the wind proof structure 200 has a generally octagonal shape. In FIGS. 9-12, the same element of the wind proof structure 10 is given the same reference number with the addition of two hundred.

The patents and publications referred to herein are hereby incorporated by reference.

Whereas particular aspects of this invention have been described above for purposes of illustration, it will be evident to those skilled in the art that numerous variations of the details of the present invention may be made without departing from the invention as defined in the appended claims.

What is claimed is:

1. A wind proof structure, comprising:
a foundation block;
a running beam anchored to the foundation block;
a plurality of perimeter columns anchored to the running beam;
a centrally located capital column anchored to the running beam; and
a dome-shaped roof anchored to the plurality of perimeter columns and the capital column.

2. The wind proof structure of claim 1, wherein the foundation block, the running beam, the exterior walls, the perimeter columns, the capital column and the dome-shaped roof are anchored to each other in such a way to form a monolithic structure that acts as if the wind proof structure is made of a single piece of material.

3. The wind proof structure of claim 1, wherein an exterior surface of the wind proof structure defines an angle, A, with respect to the running beam, thereby causing wind to deflect and dissipate causing less pressure on the wind proof structure.

4. The wind proof structure of claim 3, wherein the angle, A, is between about 100 degrees and about 120 degrees.

5. The wind proof structure of claim 1, wherein the dome-shaped roof is anchored to the plurality of perimeter columns and capital column by a plurality of beams.

6. The wind proof structure of claim 1, wherein the wind proof structure has a generally round or circular exterior shape.

7. The wind proof structure of claim 1, wherein the wind proof structure has a generally polygonal exterior shape.

8. The wind proof structure of claim 1, wherein the dome-shaped roof is made of steel.

9. The wind proof structure of claim 1, wherein the dome-shaped roof is flush with the perimeter walls to allow the wind force to pass smoothly over the wind proof structure.

10. A wind proof structure, comprising:
a foundation block;
a running beam anchored to the foundation block;
a plurality of perimeter columns anchored to the running beam;
a centrally located capital column anchored to the running beam; and
a dome-shaped roof anchored to the plurality of perimeter columns and the capital column,
wherein an exterior surface of the wind proof structure defines an angle, A, with respect to the running beam, thereby causing wind to deflect and dissipate causing less pressure on the wind proof structure, and
wherein the foundation block, the running beam, the exterior walls, the perimeter columns, the capital column and the dome-shaped roof are anchored to each other in such a way to form a monolithic structure that acts as if the wind proof structure is made of a single piece of material.

11. The wind proof structure of claim 10, wherein the angle, A, is between about 100 degrees and about 120 degrees.

12. The wind proof structure of claim 10, wherein the dome-shaped roof is anchored to the plurality of perimeter columns and capital column by a plurality of beams.

13. The wind proof structure of claim 10, wherein the wind proof structure has a generally round or circular exterior shape.

14. The wind proof structure of claim 10, wherein the wind proof structure has a generally polygonal exterior shape.

15. The wind proof structure of claim 10, wherein the dome-shaped roof is made of steel.

16. The wind proof structure of claim 10, wherein the dome-shaped roof is flush with the perimeter walls to allow the wind force to pass smoothly over the wind proof structure.

17. A method of manufacturing a wind proof structure, comprising the steps of:
anchoring a running beam anchored to a foundation block;
anchoring a plurality of perimeter columns to the running beam;
anchoring a centrally located capital column to the running beam; and
anchoring a dome-shaped roof to the plurality of perimeter columns and the capital column,
wherein an exterior surface of the wind proof structure defines an angle, A, with respect to the running beam, thereby causing wind to deflect and dissipate causing less pressure on the wind proof structure, and
wherein the foundation block, the running beam, the exterior walls, the perimeter columns, the capital column and the dome-shaped roof are anchored to each other in such a way to form a monolithic structure that acts as if the wind proof structure is made of a single piece of material.
